(19) United States
(12) Patent Application Publication
(10) Pub. No.: US 2013/0089638 A1
(43) Pub. Date: Apr. 11, 2013

(54) Compositions Comprising Maltotriose And Methods Of Using Same To Inhibit Damage Caused By Dehydration Processes

(71) Applicants: Zihua Ao, Newburgh, IN (US); Juan M. Gonzalez, Newburgh, IN (US); Bradley J. Taylor, Col. Lomas de la Ref (MX)

(72) Inventors: Zihua Ao, Newburgh, IN (US); Juan M. Gonzalez, Newburgh, IN (US); Bradley J. Taylor, Col. Lomas de la Ref (MX)

(73) Assignee: Mead Johnson Nutrition Company, Evansville, IN (US)

(21) Appl. No.: 13/270,607

(22) Filed: Oct. 11, 2011

(51) Int. Cl. A23L 3/3562; A23C 9/152

(52) U.S. Cl. 426/61; 426/271; 426/321

(57) ABSTRACT

Compositions comprising maltotriose are disclosed herein. In certain embodiments, the compositions comprise maltotriose and at least one component whose function is subject to impairment by a dehydration process, such as a live microorganism. Methods for inhibiting damage caused by dehydration are also disclosed herein. In particular embodiments, the method includes preparing a composition comprising maltotriose and at least one component whose function is subject to impairment by a dehydration process and removing water from the composition by one or more dehydration processes.

### TECHNICAL FIELD

This disclosure relates generally to compositions comprising maltotriose and methods of inhibiting damage caused, directly and indirectly, by dehydration processes.

### BACKGROUND

Dehydration processes, such as spray-drying and freeze-drying, are used in a number of fields and have a variety of benefits, such as improving stability as well as improving storage and handling properties of materials. Despite these benefits, however, the dehydration process can lead to significant damage. For example, often it is desirable to include live, beneficial microorganisms in freeze- or spray-dried nutritional compositions for human use in order in promote the growth of beneficial microorganisms in the human gut. Unfortunately, however, the dehydration process can potentially cause significant damage and oxidative stress to the cell membranes, lipids, proteins and DNA of the microorganisms. Thus, by the time the composition is administered to the human, the viability of the microorganisms may be significantly impaired, frustrating the objective of creating a favorable microbial environment in the human gut.

Trehalose and sucrose are often employed in compositions to try to preserve the functionality of materials subjected to dehydration processes. However, trehalose and sucrose themselves can lead to damage of the membrane integrity of the organism they are intended to protect; for example, both carbohydrates can form crystalline structures when subjected to dehydration processes and physically, chemically or biologically damage the other components in the composition.

Accordingly, there is a continuing need for compositions and methods that lessen damage caused by dehydration processes. In certain embodiments, this need is met by including the sugar maltotriose and, optionally, an antioxidant, an ion chelating agent and/or a negatively charged compound, in compositions subjected to one or more dehydration processes.

### BRIEF SUMMARY

Briefly, the present disclosure is directed, in an embodiment, to a method for inhibiting damage caused, either directly or indirectly, by dehydration. In one embodiment, the method includes: a) preparing a composition comprising maltotriose and at least one component whose function is subject to impairment by a dehydration process; and b) removing water from the composition by one or more dehydration processes.

In another embodiment, the disclosure is directed to a composition comprising maltotriose and at least one component whose function is subject to impairment by a dehydration process.

In certain embodiments, the compositions further comprise an antioxidant, an ion chelating agent and/or a negatively charged compound. In certain embodiments, the at least one component whose function is subject to impairment by a dehydration process is a live microorganism. In particular embodiments, the compositions are nutritional compositions comprising a fat or lipid source and a protein source.

### DETAILED DESCRIPTION

In one embodiment, the disclosure is directed to a composition comprising maltotriose and at least one component whose function is subject to impairment by a dehydration process.

By “at least one component whose function is subject to impairment by a dehydration process” is meant that the composition includes one or more entities whose function can be impaired when included in a composition that is subjected to a dehydration process. For example, as previously mentioned, dehydration of a composition including a live microorganism can significantly damage and kill live microorganisms due to oxidative stress and damage to the cell membranes, lipids, proteins, and DNA of the microorganisms. In addition to live microorganisms, the function of a variety of components, from active pharmaceutical ingredients to cosmetic ingredients, also are subject to impairment when included in a composition that is subjected to a dehydration process. Thus, the at least one component whose function is subject to impairment by a dehydration process can be a wide variety of components from therapeutic proteins to cosmetic ingredients applied to skin surfaces to live microorganisms.

Dehydration processes, however, can be particularly problematic for live microorganisms. Thus, in a preferred embodiment, the at least one component whose function is subject to impairment by a dehydration process comprises a live microorganism, preferably a live bacteria. In an especially preferred embodiment, the at least one component whose function is subject to impairment by a dehydration process comprises a live probiotic.

A “probiotic” is a microorganism with low or no pathogenicity that exerts beneficial effects on the health of the host. Any probiotic known in the art may be acceptable in this embodiment provided it achieves the intended result. In a particular embodiment, the live probiotic may be selected from Lactobacillus species, such as Lactobacillus rhamnosus GG, and Bifidobacterium species, such as Bifidobacterium longum, Bifidobacterium brevis and Bifidobacterium animalis subsp. lactis BB-12.

If included, the amount of the live probiotic may vary from about 10⁴ to about 10¹⁰ colony forming units (cfu) per kg body weight per day. In another embodiment, the amount of the live probiotic may vary from about 10⁶ to about 10⁹ cfu per kg body weight per day. In yet another embodiment, the amount of the live probiotic may be at least about 10⁶ cfu per kg body weight per day.

In addition to a live probiotic, the composition may further comprise a non-viable probiotic. The term “non-viable” or “non-viable probiotic” means non-living probiotic microorganisms, their cellular components and metabolites thereof. Such non-viable probiotics may have been heat-killed or otherwise inactivated but retain the ability to favorably influence the health of the host.

The probiotics useful in the present disclosure may be naturally-occurring, synthetic or developed through the genetic manipulation of organisms, whether such new source is now known or later developed.

Without being bound to any particular theory, it is believed that maltotriose is particularly beneficial in inhibiting damage caused by one or more dehydration processes. For example, maltotriose has a high hydration number, displaying an ability to readily interact and hold water through hydrogen bonds. Furthermore, maltotriose has an ability to form a glass-like structure with very high viscosity, which, in turn, will tend to stabilize the other components (such as cell membranes) in a composition subjected to dehydration. Moreover, unlike sucrose and trehalose, maltotriose does not tend to crystallize. Thus, in a preferred embodiment, the compositions of the disclosure comprising maltotriose are subjected to one or more dehydration processes. It is also preferred that the maltotriose is present in the composition in an amount effective to inhibit damage to the component whose function is subject to impairment by a dehydration process.

The compositions of the disclosure may contain, for example, between about 4% and about 80% by weight maltotriose. Preferably, the compositions contain between about 5% and about 50% by weight maltotriose.

As used herein, “maltotriose” refers to the trisaccharide maltotriose, including all isomers of maltotriose, such as isomaltotriose. Maltotriose useful in the present disclosure includes maltotriose in free form as well as maltotriose-containing and maltotriose-enriched compositions, such as maltodextrins or syrup solids with a high maltotriose content. Maltodextrins or syrup solids with a high maltotriose content can be prepared, for example, using the enzyme known as maltotriose-forming alpha-amylase, available from Amano Enzyme Inc.

As mentioned, the compositions comprise maltotriose and at least one component whose function is subject to impairment by a dehydration process and, in certain embodiments, the compositions are subjected to one or more dehydration processes. For purposes of the present disclosure, a “dehydration process” or “dehydration processes” mean any process in which water is removed from a composition. Dehydration processes include but are not limited to all forms of active drying, such as vacuum-drying, spray-drying and freeze-drying (otherwise known as lyophilizing), and all forms of passive drying, such as evaporation. In a preferred embodiment, the compositions comprise at least one component whose function is subject to impairment by spray-drying and/or freeze-drying and the compositions are spray-dried and/or freeze-dried. It is also preferred that the compositions include maltotriose in an amount effective to inhibit damage to the at least one component that would otherwise be caused by spray-drying and/or freeze-drying the composition. Freeze-drying and spray-drying are processes well-known to the skilled artisan and extensively used in a variety of industries. References describing various spray-drying and freeze-drying processes include U.S. Pat. Nos. 5,632,100, 6,308,434, 6,463,675, and U.S. Patent Publication Nos. 2008/0032962 and 2010/0107436, the disclosures of which are all incorporated by reference in their entirety.

Apart from maltotriose, the compositions may include additional components that inhibit dehydration-induced damage to the at least one component whose function is subject to impairment by a dehydration process. For example, it has been found that when hydrophilic moieties are dissolved in water there is a physically distinct and less mobile water phase of the solute surface called an exclusion zone. The presence of such zones could impact ice nucleation, especially where there is a presence of negatively charged solutes. In addition, it has been suggested that water freezing is facilitated by positively charged compounds, while negatively charged compounds inhibit water freezing. Thus, including negatively charged compounds in a composition subjected to dehydration may inhibit dehydration-induced damage, such as ice formation on the surface of the at least one component.

Accordingly, in a preferred embodiment, in addition to maltotriose and the at least one component whose function is subject to impairment by a dehydration process, the compositions further include a negatively charged compound. Those skilled in the art will appreciate that the charge of certain compounds, such as proteins, depends on the compound's isoelectric point and the pH of the composition to which the compound is added. Therefore, as used herein, a “negatively charged compound” means a component that has a negative overall charge at the pH of the composition that is subjected to one or more dehydration processes. Negatively charged compounds useful for the present disclosure include but are not limited to amino acids and salts thereof, salts of phosphates and sulfates, peptides, proteins, and/or carbohydrates. Especially preferred proteins include whey and casein proteins.

Preferably, the negatively charged compound is present in an amount effective to inhibit or slow water freezing on the surface of the at least one component whose function is subject to damage by a dehydration process. In a particularly preferred embodiment, the at least one component whose function is subject to damage by a dehydration process is a live microorganism. Although surfaces of cell membranes contain negatively charged compounds such as phospholipids and glycoproteins, these compounds are not able to prevent removal of hydrogen-bonded water from the cell membrane surface during drying to make a low hydration material. Thus, in a preferred embodiment, the negatively charged compound is present in an amount effective to inhibit or slow water freezing on the surface of the cell membrane of a live microorganism during freezing. For example, if included in the compositions of the disclosure, the negatively charged compounds may comprise between about 0.1% and about 75%, more preferably between about 2% and about 20%, of the total weight of the composition.

Furthermore, dehydration may also lead to enrichment of metal ions and reactive oxygen/nitrogen species surrounding the at least one component whose function is subject to damage by a dehydration process, leading to oxidative stress and damage and/or physical damage. Thus, in one embodiment, in addition to maltotriose and the at least one component whose function is subject to impairment by a dehydration process, the compositions further include an antioxidant and/or an ion chelating agent. Antioxidants and ion chelating agents useful for the present disclosure include but are not limited to vitamin C, polyphenols, vitamin E, citrate salts, amino acids, peptides, proteins and/or phosphate salts.

Preferably, the antioxidant and/or ion chelating agent is present in an amount effective to inhibit oxidative stress, oxidative damage and/or physical damage to the at least one component whose function is subject to damage by a dehydration process. For example, enrichment of metal ions and reactive oxygen/nitrogen species by the dehydration process could cause oxidative stress to the cell membranes of live microorganisms and oxidative stress and damage to lipids, proteins and DNA of the microorganisms. Dehydration may also lead to physical damage to the cell membranes of the live microorganisms. Thus, in a preferred embodiment, the at least one component whose function is subject to impairment by a dehydration process is a live microorganism and the antioxidant and/or ion chelating agent is present in an amount effective to inhibit oxidative stress, oxidative damage and/or physical damage. For example, if included in the compositions of the disclosure, the antioxidants and/or ion chelating agents may comprise between about 0.1% and about 40%, more preferably between about 0.5% and about 10%, and most preferably between about 1% and about 5%, of the total weight of the composition.

In a preferred embodiment, the compositions comprising maltotriose and at least one component whose function is subject to impairment by a dehydration process are intended for use in, or administration to, a mammal, preferably a human. For example, in a preferred embodiment, the composition is a nutritional composition, a pharmaceutical composition or a cosmetic composition. In a particularly preferred embodiment, the composition is a nutritional composition comprising a fat or lipid source and a protein source.

In certain embodiments, the nutritional compositions are administered to a child or an infant. As used herein, a “child” and “children” are defined as humans over the age of 12 months to about 12 years old. The term “infant” is generally defined as a human from about birth to 12 months of age. In an especially preferred embodiment, the composition is an infant formula.

The term “infant formula” applies to a composition in liquid or powdered form that satisfies the nutrient requirements of an infant by being a substitute for human milk. In the United States, the content of an infant formula is dictated by the federal regulations set forth at 21 C.F.R. §§100, 106 and 107. These regulations define macronutrient, vitamin, mineral, and other ingredient levels in an effort to simulate the nutritional and other properties of human breast milk. In a separate embodiment, the nutritional product may be a human milk fortifier, meaning it is a composition which is added to human milk in order to enhance the nutritional value of human milk. As a human milk fortifier, the disclosed composition may be in powder or liquid form. In yet another embodiment, the disclosed nutritional product may be a children's nutritional composition.

If the composition is a nutritional composition, the nutritional compositions may provide minimal, partial, or total nutritional support. The nutritional compositions may be nutritional supplements or meal replacements. In some embodiments, the nutritional compositions may be administered in conjunction with a food or another nutritional composition. In this embodiment, the nutritional compositions can either be intermixed with the food or other nutritional composition prior to ingestion by the subject or can be administered to the subject either before or after ingestion of a food or nutritional composition. The nutritional compositions may be administered to preterm infants receiving infant formula, breast milk, a human milk fortifier, or combinations thereof. A “full term infant” as used herein, means an infant born after at least about 37 weeks gestation, while a “preterm infant” is an infant born after less than about 37 weeks gestation.

The nutritional compositions may, but need not, be nutritionally complete. The skilled artisan will recognize “nutritionally complete” to vary depending on a number of factors including, but not limited to, age, clinical condition, and dietary intake of the subject to whom the term is being applied. In general, “nutritionally complete” means that the nutritional composition of the present disclosure provides adequate amounts of all carbohydrates, lipids, essential fatty acids, proteins, essential amino acids, conditionally essential amino acids, vitamins, minerals, and energy required for normal growth. As applied to nutrients, the term “essential” refers to any nutrient which cannot be synthesized by the body in amounts sufficient for normal growth and to maintain health and which therefore must be supplied by the diet. The term “conditionally essential” as applied to nutrients means that the nutrient must be supplied by the diet under conditions when adequate amounts of the precursor compound is unavailable to the body for endogenous synthesis to occur.

The composition which is “nutritionally complete” for the preterm infant will, by definition, provide qualitatively and quantitatively adequate amounts of all carbohydrates, lipids, essential fatty acids, proteins, essential amino acids, conditionally essential amino acids, vitamins, minerals, and energy required for growth of the preterm infant. The composition which is “nutritionally complete” for the full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant. The composition which is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

The nutritional composition may be provided in any form known in the art, including a powder, a gel, a suspension, a paste, a solid, a liquid, a liquid concentrate, or a ready-to-use product. As noted above, in one preferred embodiment, the nutritional composition is an infant formula, especially an infant formula adapted for use as sole source nutrition for an infant.

In the preferred embodiments, the nutritional product disclosed herein may be administered enterally. As used herein, “enteral” means through or within the gastrointestinal, or digestive, tract, and “enteral administration” includes oral feeding, intragastric feeding, transpyloric administration, or any other introduction into the digestive tract.

Suitable fat or lipid sources for inclusion in a nutritional composition may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palmolein, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

The nutritional compositions may further comprise bovine milk protein. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof.

In one embodiment, the proteins are provided as intact proteins. In other embodiments, the proteins are provided as a combination of both intact proteins and hydrolyzed proteins, with a degree of hydrolysis of between about 3% and 70%. In other embodiments, the degree of hydrolysis of the proteins is between about 4% and about 10%. In yet another embodiment, the protein source may be supplemented with glutamine-containing peptides.

In a particular embodiment of the disclosure, the protein source comprises whey and casein proteins and the ratio of whey to casein proteins ratio is similar to that found in human breast milk. For example, in certain embodiments, the weight ratio of whey to casein proteins is from about 40% whey:60% casein to about 80% whey:20% casein.

The nutritional compositions, in some embodiments, may further contain a source of long chain polyunsaturated fatty acids (LCPUFAs). Preferably, the source of LCPUFAs comprise docosahexanoic acid (DHA). Other suitable LCPUFAs include, but are not limited to, α-linoleic acid, γ-linoleic acid, linoleic acid, linolenic acid, eicosapentanoic acid (EPA) and arachidonic acid (ARA).

In one embodiment, the nutritional composition is supplemented with both DHA and ARA. In this embodiment, the weight ratio of ARA:DHA may be from about 1:3 to about 9:1. In one embodiment of the present disclosure, the weight ratio of ARA:DHA is from about 1:2 to about 4:1.

The amount of long chain polyunsaturated fatty acids in the nutritional composition may vary from about 5 mg/100 kcal to about 100 mg/100 kcal, more preferably from about 10 mg/100 kcal to about 50 mg/100 kcal.

The nutritional composition may be supplemented with oils containing DHA and ARA using standard techniques known in the art. For example, DHA and ARA may be added to the composition by replacing an equivalent amount of an oil, such as high oleic sunflower oil, normally present in the composition. As another example, the oils containing DHA and ARA may be added to the composition by replacing an equivalent amount of the rest of the overall fat blend normally present in the composition without DHA and ARA.

If utilized, the source of DHA and ARA may be any source known in the art such as marine oil, fish oil, single cell oil, egg yolk lipid, and brain lipid. In some embodiments, the DHA and ARA are sourced from the single cell Martek oil, DHASCO®, ARASCO®, or variations thereof. The DHA and ARA can be in natural form, provided that the remainder of the LCPUFA source does not result in any substantial deleterious effect on the infant. Alternatively, the DHA and ARA can be used in refined form.

In an embodiment of the present disclosure, sources of DHA and ARA are single cell oils as taught in U.S. Pat. Nos. 5,374,567; 5,550,156; and 5,397,591, the disclosures of which are incorporated herein in their entirety by reference. However, the present disclosure is not limited to only such oils.

In one embodiment of the disclosure, the nutritional compositions may include a prebiotic composition comprising one or more prebiotics. As used herein, the term “prebiotic” means a non-digestible food ingredient that beneficially affects the host by selectively stimulating the growth and/or activity of one or a limited number of bacteria in the colon that can improve the health of the host. A “prebiotic composition” is a composition that comprises one or more prebiotics. Such prebiotics may be naturally-occurring, synthetic, or developed through the genetic manipulation of organisms and/or plants, whether such new source is now known or developed later.

Prebiotics useful in the present disclosure may include oligosaccharides, polysaccharides, and other prebiotics that contain fructose, xylose, soya, galactose, glucose and mannose. More specifically, prebiotics useful in the present disclosure may include lactulose, lactosucrose, raffinose, gluco-oligosaccharide, inulin, polydextrose, polydextrose powder, galactooligosaccharide, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, and gentio-oligosaccharides. Preferably, the nutritional compositions comprise polydextrose and/or galactooligosaccharide. Optionally, in addition to polydextrose and/or galactooligosaccharide, the nutritional compositions comprise one or more additional prebiotics. In certain embodiments, the prebiotic included in the compositions of the present disclosure include those taught by U.S. Pat. No. 7,572,474, the disclosure of which is incorporated herein by reference.

If included in the nutritional compositions, the total amount of prebiotics present in the nutritional composition may be from about 0.1 g/100 kcal to about 1 g/100 kcal. More preferably, the total amount of prebiotics present in the nutritional composition may be from about 0.3 g/100 kcal to about 0.7 g/100 kcal. At least 20% of the prebiotics should comprise galactooligosaccharide and/or polydextrose.

If polydextrose is used in the prebiotic composition, the amount of polydextrose in the nutritional composition may, in an embodiment, be within the range of from about 0.1 g/100 kcal to about 1.0 g/100 kcal. In another embodiment, the amount of polydextrose is within the range of from about 0.2 g/100 kcal to about 0.6 g/100 kcal.

If galactooligosaccharide is used in the prebiotic composition, the amount of galactooligosaccharide in the nutritional composition may, in an embodiment, be from about 0.1 g/100 kcal to about 1.0 g/100 kcal. In another embodiment, the amount of galactooligosaccharide in the nutritional composition may be from about 0.2 g/100 kcal to about 0.5 g/100 kcal. In certain embodiments, the ratio of polydextrose to galactooligosaccharide in the prebiotic composition is between about 9:1 and about 1:9.

Preferably, the total amount of carbohydrates in the nutritional composition is from about 8 g/100 kcal to about 14 g/100 kcal, more preferably from about 9 g/100 kcal to about 13 g/100 kcal.

The nutritional composition of the disclosure also includes lactoferrin in some embodiments. Lactoferrins are single chain polypeptides of about 80 kD containing 1-4 glycans, depending on the species. The 3-D structures of lactoferrin of different species are very similar, but not identical. Each lactoferrin comprises two homologous lobes, called the N- and C-lobes, referring to the N-terminal and C-terminal part of the molecule, respectively. Each lobe further consists of two sub-lobes or domains, which form a cleft where the ferric ion (Fe³⁺) is tightly bound in synergistic cooperation with a (bi)carbonate anion. These domains are called N1, N2, C1 and C2, respectively. The N-terminus of lactoferrin has strong cationic peptide regions that are responsible for a number of important binding characteristics. Lactoferrin has a very high isoelectric point (˜pI 9) and its cationic nature plays a major role in its ability to defend against bacterial, viral, and fungal pathogens. There are several clusters of cationic amino acids residues within the N-terminal region of lactoferrin mediating the biological activities of lactoferrin against a wide range of microorganisms. For instance, the N-terminal residues 1-47 of human lactoferrin (1-48 of bovine lactoferrin) are critical to the iron-independent biological activities of lactoferrin. In human lactoferrin, residues 2 to 5 (RRRR) and 28 to 31 (RKVR) are arginine-rich cationic domains in the N-terminus especially critical to the antimicrobial activities of lactoferrin. A similar region in the N-terminus is found in bovine lactoferrin (residues 17 to 42; FKCRRWQWRMKKLGAPSITCVRRAFA).

The nutritional composition may further include lactoferrin. As described in “Perspectives on Interactions Between Lactoferrin and Bacteria” which appeared in the publication BIOCHEMISTRY AND CELL BIOLOGY, pp 275-281 (2006), lactoferrins from different host species may vary in their amino acid sequences though commonly possess a relatively high isoelectric point with positively charged amino acids at the end terminal region of the internal lobe. Suitable lactoferrins for use in the present disclosure include those having at least 48% homology with the amino acid sequence AVGEQELRKCNQWSGL at the HLf (349-364) fragment. For example, suitable lactoferrins include, without limitation, human lactoferrin, bovine lactoferrin, porcine lactoferrin, equine lactoferrin, buffalo lactoferrin, goat lactoferrin, murine lactoferrin and camel lactoferrin.

In a preferred embodiment, the lactoferrin is lactoferrin from a non-human source. As used herein, “lactoferrin from a non-human source” means lactoferrin which is from a source other than human breast milk. For example, in certain embodiments, the lactoferrin is human lactoferrin produced by a genetically modified organism and/or non-human lactoferrin. The term “non-human lactoferrin”, as used herein, refers to lactoferrin having an amino acid sequence that is different than the amino acid sequence of human lactoferrin.

In one embodiment, lactoferrin is present in the nutritional compositions in an amount of from about 70 mg/100 kcal to about 220 mg/100 kcal; in another embodiment, lactoferrin is present in an amount of about 90 mg/100 kcal to about 190 mg/100 kcal. Nutritional compositions for infants can include lactoferrin in the quantities of from about 0.5 mg to about 1.5 mg per milliliter of formula. In nutritional compositions replacing human milk, lactoferrin may be present in quantities of from about 0.6 mg to about 1.3 mg per milliliter of formula.

### EXAMPLES

The following examples are provided to illustrate some embodiments of the composition of the present disclosure but should not be interpreted as any limitation thereon. Other embodiments within the scope of the claims herein will be apparent to one skilled in the art from the consideration of the specification or practice of the composition or methods disclosed herein. It is intended that the specification, together with the example, be considered to be exemplary only, with the scope and spirit of the disclosure being indicated by the claims which follow the example.

### Example 1

This example illustrates a nutritional composition prepared according to the present disclosure.

A liquid composition of corn syrup solids is prepared and the corn syrup solids are enriched with maltotriose using the enzyme maltotriose-forming alpha-amylase (Amano Enzyme Inc). After enrichment, about 45%, by weight, of the corn syrup solids contains maltotriose. The liquid composition comprising maltotriose-enriched corn syrup solids is combined with liquid compositions containing whey and casein proteins, live Lactobacillus rhamnosus GG, a fat blend, vitamin C, polyphenols and vitamin E in the proportions shown in the below table. The combined liquid composition is freeze-dried into powder form. After 6 months of storage, the powder is reconstituted in water, and the cell membranes of the Lactobacillus rhamnosus GG exhibit little oxidative stress and physical damage and the lipids, proteins and DNA of the microorganisms also exhibit little oxidative stress and damage.

| Ingredient | Weight Percentage |
|---|---|
| Corn Syrup Solids Enriched with | 40% |
| Maltotriose | |
| Whey/Casein Proteins | 5% |
| Lactobacillus rhamnosus GG suspension | 45% |
| Fat Blend | 3% |
| Vitamin C | 1% |
| Polyphenols | 1% |
| Vitamin E | 1% |
| Other Carbohydrates, Vitamins and | 4% |
| Minerals | |

### Example 2

This example illustrates a pharmaceutical composition prepared according to the present disclosure.

A liquid composition comprising the below mentioned ingredients is prepared and then freeze-dried into powder form. The majority of amino acids used have a negative overall charge at a pH of 7.0. After 6 months of storage, the powder is reconstituted in water, and the human growth hormone exhibits little oxidative stress and physical damage.

| Ingredient | Weight Percentage |
|---|---|
| Maltotriose | 40% |
| Human Growth Hormone solution | 10% |
| Amino Acids | 10% |
| Vitamin C | 0.5% |
| Polyphenols | 1% |
| Vitamin E | 0.5% |
| Other Excipients solution | 38% |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although preferred embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged both in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

What is claimed is:

1. A method for inhibiting damage caused by dehydration comprising:
a) preparing a composition comprising maltotriose and a live microorganism; and
b) removing water from the composition by one or more dehydration processes.

2. The method according to claim 1, wherein the step of removing water from the composition comprises freeze-drying the composition.

3. The method according to claim 1, wherein the step of removing water from the composition comprises spray-drying the composition.

4. The method according to claim 1, wherein the composition is a nutritional composition comprising a fat or lipid source and a protein source.

5. The method according to claim 1, wherein the composition is an infant formula.

6. The method according to claim 1, wherein the live microorganism comprises a live probiotic.

7. The method according to claim 6, wherein the live probiotic is selected from the group consisting of Lactobacillus species, Bifidobacterium species and combinations thereof.

8. The method according to claim 1, wherein the composition further comprises a negatively charged compound.

9. The method according to claim 8, wherein the negatively charged compound is selected from the group consisting of amino acids and salts thereof, salts of phosphates, salts of sulfates, peptides, proteins, carbohydrates and combinations thereof.

10. The method according to claim 8, wherein the negatively charged compound is present in an amount effective to inhibit or slow water freezing on the cell membrane of the live microorganism.

11. The method according to claim 1, wherein the composition further comprises at least one compound selected from the group consisting of antioxidants, ion chelating agents and combinations thereof.

12. The method according to claim 11, wherein the at least one compound is selected from the group consisting of vitamin C, polyphenols, vitamin E, citrate salts, amino acids, peptides, proteins, phosphate salts and combinations thereof.

13. The method according to claim 11, wherein the at least one compound is present in an amount effective to inhibit dehydration-induced oxidative stress and physical damage to the cell membrane of the live microorganism.

14. The method according to claim 11, wherein the at least one compound is present in an amount effective to inhibit dehydration-induced oxidative stress and damage to the lipids, proteins and DNA of the live microorganism.

15. A method for inhibiting damage caused by dehydration comprising:
a) preparing a composition comprising maltotriose, at least one component whose function is subject to impairment by a dehydration process, and at least one compound selected from the group consisting of negatively charged compounds, antioxidants, ion chelating agents and combinations thereof; and
b) removing water from the composition by one or more dehydration processes.

16. The method according to claim 15, wherein the at least one component whose function is subject to impairment by a dehydration process comprises a live microorganism.

17. A composition comprising:
a) maltotriose;
b) a live microorganism; and
c) at least one compound selected from the group consisting of negatively charged compounds, antioxidants, ion chelating agents and combinations thereof.

18. The composition according to claim 17, wherein the composition has been subjected to spray-drying.

19. The composition according to claim 17, wherein the composition has been subjected to freeze-drying.

20. The composition according to claim 17, wherein the composition is a nutritional composition comprising a fat or lipid source and a protein source.
